(19) United States
(12) Patent Application Publication
(10) Pub. No.: US 2009/0261120 A1
(43) Pub. Date: Oct. 22, 2009

(54) Stereoscopic Video Vending Machine

(76) Inventor: Robert L. Terry, Houston, TX (US)

Correspondence Address: ANDREWS & KURTH, L.L.P., 600 TRAVIS, SUITE 4200, HOUSTON, TX, 77002, US

(21) Appl. No.: 12/426,002

(22) Filed: Apr. 17, 2009

Related U.S. Application Data
(60) Provisional application No. 61/045,857, filed on Apr. 17, 2008.

(51) Int. Cl. B65D 83/00; H04N 13/04; H04N 5/00

(52) U.S. Cl. 221/282; 348/51; 386/126; 348/E13.001

(57) ABSTRACT

A vending machine with a stereoscopic three-dimensional display and a method for vending wares in conjunction with a video presentation shown on the display. The video presentation is divided into left and right views for the left and right eyes, respectively. A face plate with left and right ocular apertures is disposed on an exterior surface of the vending machine in an optimal position for viewing. A divider plate is centered between the left and right views and the left and right ocular apertures so that a viewer's left eye can only see the left view of the video presentation and vice-versa. When a purchaser buys a product from the vending machine, the purchaser may view a short video presentation through the stereoscopic display, which depicts something of interest to the viewer.

### CROSS REFERENCE TO RELATED APPLICATION

This application is based upon provisional application 61/045,857 filed on Apr. 17, 2008, the priority of which is claimed.

### BACKGROUND OF THE INVENTION

1. Field of the Invention

This invention pertains to vending machines generally, and particularly to vending machines that target children, such as gumball machines.

2. Description of the Prior Art

The child-consumer market is large. Children consume bubble gum, candy, drinks, toys and entertainment. Vending machines that dispense these items are typically placed in grocery, drug and dry goods stores at the entrances and near the checkout stands. The vending machines employ catchy displays and bright colors to draw attention and entice youngsters to buy their wares.

FIG. 1 shows various gumball vending machines of prior art. Machines that entertain while dispensing goods, such as by rolling gum drops down a long spiral chute, tend to have greater sales than machines that do not employ such visual stimuli.

3. Identification of Features of the Invention

A primary feature of the invention is the provision of a three-dimensional video display for entertainment in conjunction with or independently of the sale of goods.

### SUMMARY OF THE INVENTION

The features identified above, as well as other benefits of the invention are incorporated in one or more embodiments of an improved vending machine with an integrated three-dimensional display.

In a preferred embodiment, the three-dimensional display is a stereoscopic display that is created from a single liquid crystal display (LCD), plasma display, cathode-ray tube, or similar monitor that displays a video presentation. The video presentation is divided into left and right views for the left and right eyes, respectively. A face plate with left and right ocular apertures is disposed on an exterior surface of the vending machine in an optimal position for viewing by the target audience. A divider plate is disposed perpendicularly between the video display monitor and the face plate. The divider plate is centered between the left and right views and the left and right ocular apertures so that a viewer's left eye can only see the left view of the video presentation and vice-versa. Ocular lenses may be fitted into the ocular apertures for bringing the video display into focus for the viewer. In this manner, an inexpensive simulated three-dimensional display is provided without the need for polarized or colorized eye glasses.

When a purchaser buys a product from the vending machine, the purchaser may view a short video presentation through the stereoscopic display, described above, which depicts something of interest to the viewer. For example, an animated video may show a gum drop being fabricated in a torturous mouse-trap-like process complete with chutes, conveyors, bumpers, hoppers, presses, etc. As the video displays the gumball leaving the pinball-machine-like production line, an actual gumball is dispensed by the vending machine. The video presentation may be animated or filmed.

The video presentations, which are preferably stored on some type of computer medium, such as a digital video disk (DVD), compact disk read only memory (CD-ROM), flash card memory or the like, can be changed at each transaction to entice a consumer to make numerous purchases from the vending machine. The videos may also be topical, displaying, for example, pumpkins during Halloween and reindeer during Christmas.

The vending machine includes ordinary mechanisms known in the prior art for collecting money and dispensing goods.

### BRIEF DESCRIPTION OF THE DRAWINGS

FIG. 1 shows bubblegum vending machines of prior art;

FIG. 2 is a front view of a bubblegum vending machine according to a preferred embodiment of the invention, showing an ocular place plate through which a purchaser views a stereoscopic video presentation;

FIG. 3 is a side view of the bubblegum vending machine of FIG. 2;

FIG. 4 is a functional diagram of the bubblegum vending machine of FIG. 3 showing an ocular face plate, video display monitor, divider plate, video player unit, coin operator, gumball reservoir, and dispensing mechanism;

FIG. 5 is a frontal view of the video display monitor of the vending machine of FIG. 4 showing an animated video scene with left and right views for creating a stereoscopic three-dimensional display;

FIG. 6 is a frontal view of the ocular faceplate of vending machine of FIG. 4 showing left and right ocular apertures for viewing the left and right views of the video display of FIG. 5, respectively;

FIG. 7 is an exploded diagram showing the video display monitor of FIG. 5, the ocular faceplate of FIG. 6, and an opaque divider plate for segregating the left and right views;

FIG. 8 is a functional side view of an alternate embodiment of a gumdrop vending machine showing a commercial off-the-shelf portable DVD player or laptop computer that is situated within the vending machine cabinet to produce the desired stereoscopic display; and

FIG. 9 is a storyboard illustration showing scenes from an example animated video according to an embodiment of the invention for entertaining children purchasers of gumballs.

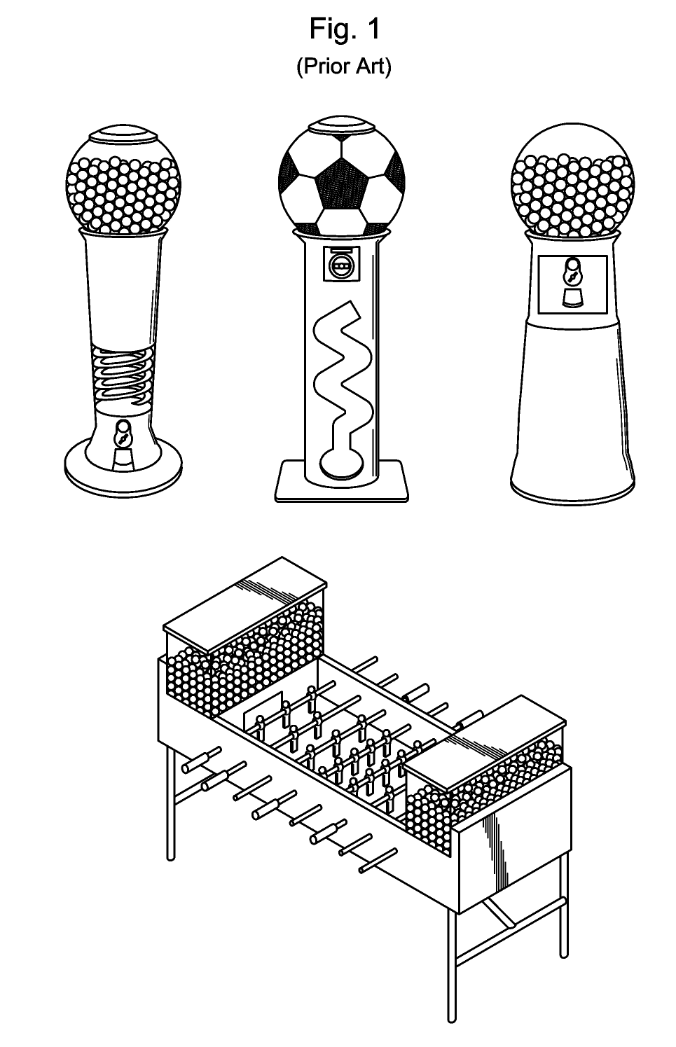

### DESCRIPTION OF THE PREFERRED EMBODIMENT OF THE INVENTION

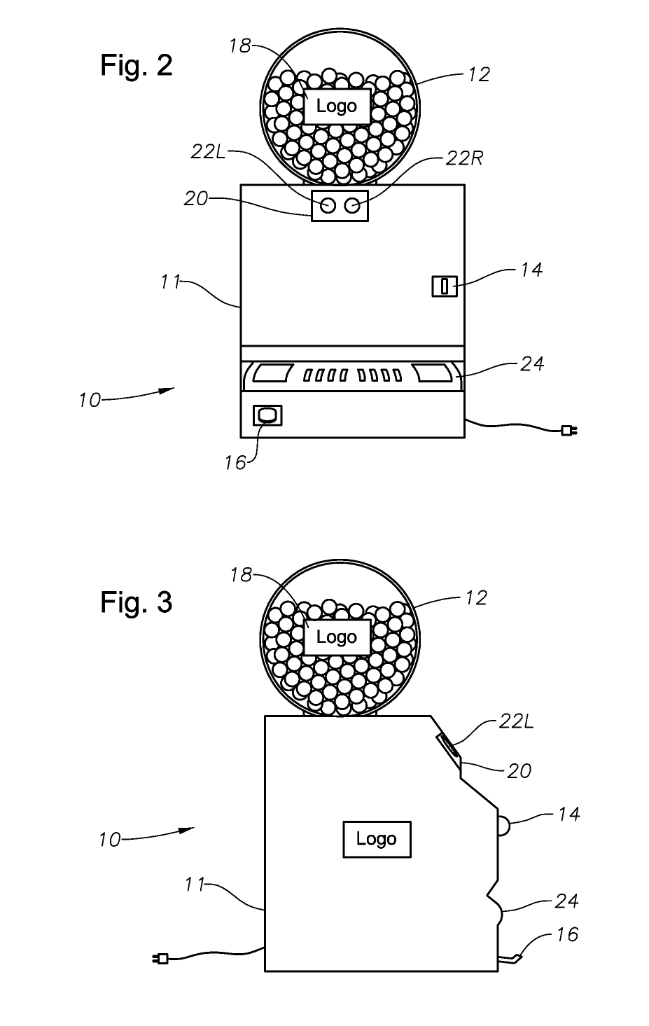

FIGS. 2 and 3 show front and side views, respectively, of a bubblegum vending machine 10 according to a preferred embodiment of the invention. However, the invention is not limited to bubblegum machines but applies to vending machines that sell any number of items. Like vending machines of prior art, vending machine 10 includes a chassis or cabinet 11, a reservoir or compartment 12 for storing its wares, an acceptor 14 (a coin or dollar bill lock box or a credit card device) for receiving payment, and a bin 16 into which the purchased wares are dispensed. Vending machine 10 may also include printed signs or other promotional labels or emblems 18. According to a preferred embodiment of the invention, vending machine 10 includes a face plate 20 with left and right ocular apertures 22L, 22R, respectively, through which a purchaser views a video presentation. Vending machine 10 may further include one or more speakers 24 through which an audio soundtrack that corresponds to the video presentation is broadcast.

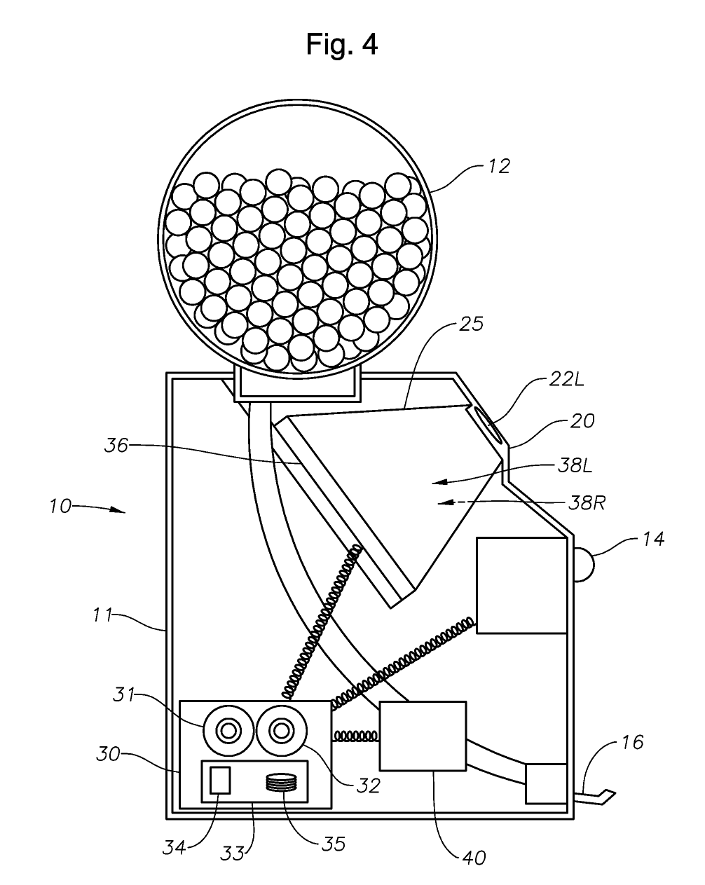

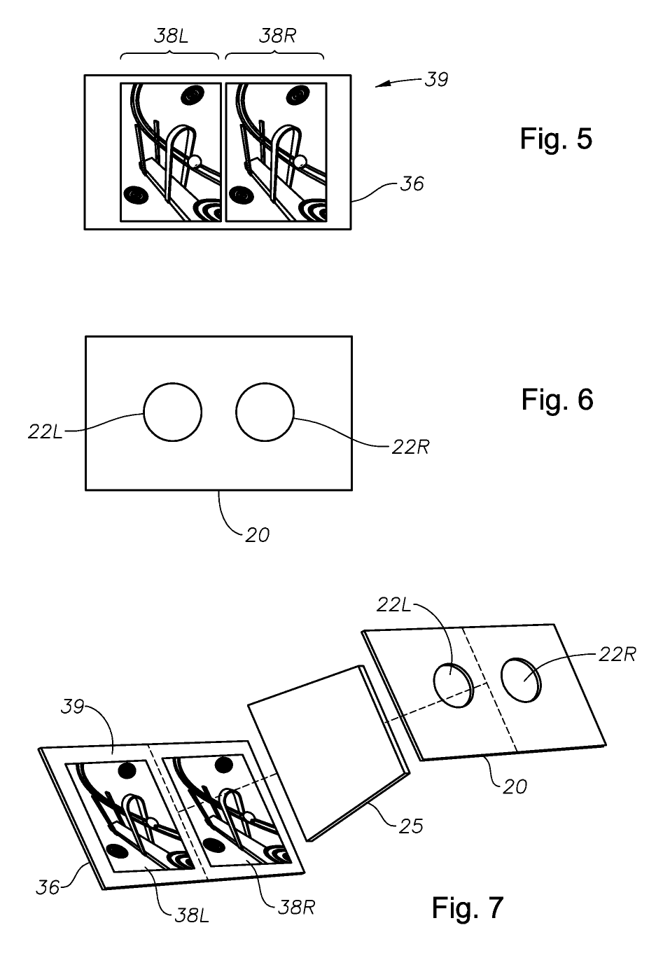

FIG. 4 is a functional view of the left side of vending machine 10. A video player 30, such as a DVD player 31, CD-ROM player 32, or computer 33 (with flash memory 34 or hard disk 35) is included within the chassis 11. Upon acknowledgment of payment, acceptor 14 sends a signal to a video player 30, which causes a video presentation to be displayed on a video monitor 36. Video monitor 36 may be an LCD, plasma or CRT display as is known in the art. After video player 30 has finished displaying the video presentation, video player 30 sends a signal to a dispenser mechanism 40 that causes a product to be dispensed from compartment 12 into bin 16. As discussed in greater detail below with respect to FIGS. 5-7, a divider plate 25 bisects video display 36 and faceplate 20 to prevent the viewer's left eye from seeing the right-side view 38R of display monitor 36, and vice-versa.

FIG. 5 is a front view of video displaying monitor 36 display left and right views 38L, 38R, respectively, of a video presentation 39, in this example a spiral chute upon which a gum drop rolls. Other video presentation themes may be used.

Stereoscopic vision depends upon delivering a unique view to each eye, which differs from the view in the other eye in the same way that our two eyes normally see two views of a scene or object. That is, the two eyes have slightly different points of view from each other because of the separation, or interocular distance from the center of one eye to the center of the other eye. These two different points of view combine in the mind to give the viewer a sense of depth. By isolating each eye, one is able to deliver separate drawings or photographs to each in a way that simulates the spatial differences as would be seen in real life, thereby imparting a feeling of depth to the scene. This isolation may be achieved through blocking or filtering, such as with polarized or colored filters, or with physical isolation, such as with mirrors or solid surfaces, such as divider plate 25.

For example, a live scene is recorded with two cameras. The cameras are situated side-by-side, separated by a distance scaled to the scene, to simulate the ocular distance between human eyes. A similar process can be used for computer generated animation by generating videos for two adjacent points of view, i.e., by using two virtual cameras filming a virtual scene.

FIG. 6 is a front view of faceplate 20 showing left and right ocular apertures 22L, 22R, respectively. The apertures 22L, 22R may include optical lenses to bring video monitor 36 into focus.

FIG. 7 is a perspective exploded diagram showing video monitor 36 with left and right views 38L, 38R of video presentation 39 and faceplate 20 with left and right ocular apertures 22L, 22R. An opaque divider plate 25 is perpendicularly disposed and centered between monitor 36 and faceplate 20. Thus, the two video views 38L, 38R are displayed simultaneously, side-by-side, on video monitor 36. The viewer, looking through the two ocular apertures 22L, 22R on the front of the vending unit 10, sees the two scenes on the screen separately, one with each eye, corresponding to the two views created by the left and right cameras by which the video presentation 39 was made. Each view is positioned in such a way as to center the view of each eye to the center of that eye's view, as it would be seen in real life. This positioning may be achieved by mirrors, by prisms, or by direct viewing, if the pictures are small enough to be centered for a full view before each eye. The two views 38L, 38R are displayed in a synchronized sequence which will appear to the viewer to exist three-dimensionally.

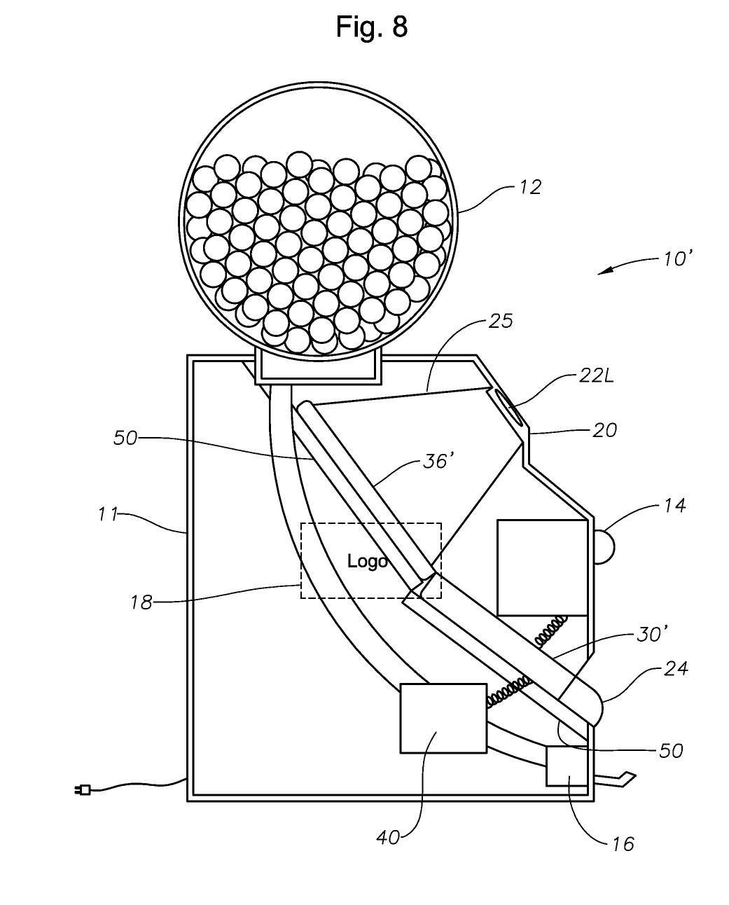

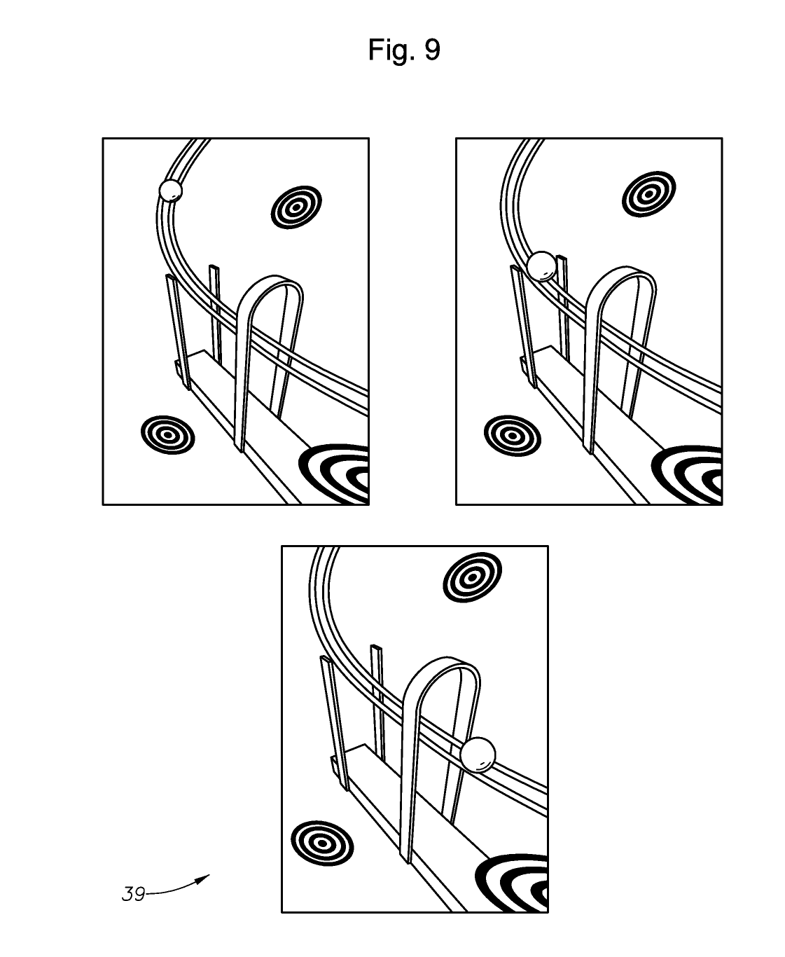

FIG. 8 shows an alternate vending machine 10′ which is nearly the same as vending machine 10 of FIG. 4, except that vending machine 10′ of FIG. 8 employs a standard off-the-shelf DVD player or laptop 30′ with LCD monitor 36′. A shelf 50 provides a pedestal upon which video player 30′ rests.

FIG. 9 is a story board illustration of an exemplar animated video presentation 39 according to a preferred embodiment of the invention. FIG. 9 depicts a mousetrap or pinball-like contraption that forms and delivers gumballs. Alternate video presentations, whether animated or filmed, may be used.

Although vending machine 10 is described as employing video monitor 36 inside chassis 11, video monitor 36 may be disposed on the outside the unit. Additionally, two single independent video monitors may be used, one for the left view 38L and the other for the right view 38R, in place of a single monitor 36 that displays both views side-by-side.

In an alternate embodiment, the invention is incorporated in an amusement device without the vending machine capabilities disclosed above. The amusement device preferably employs the same stereoscopic video arrangements as discussed above, and may be used to show fairy tale stories and the like.

While some embodiments of the invention have been illustrated in detail, the invention is not limited to the embodiments shown; modifications and adaptations of the above embodiment may occur to those skilled in the art. Such modifications and adaptations are in the spirit and scope of the invention.

What is claimed is:

1. A vending apparatus (10) comprising:
a chassis (11);
a reservoir (12) coupled to said chassis and arranged for storing a supply of goods to be sold;
a bin (16) coupled to said chassis and arranged for presenting at least one of said supply of goods to a user;
a dispenser mechanism (40) coupled to said reservoir and arranged to selectively cause said at least one of said supply of goods to be transferred from said reservoir to said bin;
an acceptor assembly (14) coupled to said chassis and arranged for receiving a payment from said user, said acceptor assembly in communication with said dispenser mechanism for causing said dispenser mechanism to selectively cause said at least one of said supply of goods to be transferred from said reservoir to said bin upon said acceptor assembly receiving said payment from said user;
a video monitor (36) coupled to said chassis and arranged to be optically visible by said user; and
a video player (30) coupled to said chassis and in communication with said video monitor and said acceptor assembly, said video player arranged for displaying a video presentation (39) on said video monitor upon said acceptor assembly receiving said payment from said user.

2. The vending apparatus (10) of claim 1 further comprising:
a face plate (20) coupled to said chassis, said faceplate having left and right ocular apertures (22L, 22R) and arranged so that said user can view said video presentation on said video monitor through at least one of said left and right ocular apertures.

3. The vending apparatus (10) of claim 2 further comprising:
a divider plate (25) coupled between said video display and said faceplate, said divider plate defining left and right view regions (38L, 38R) of said video display so that said user can see the left view region but not the right view region through said left ocular aperture and can see the right view region but not the left view region through said right ocular aperture;
wherein said video presentation is arranged to display left and right stereoscopic images on said left and right view images, respectively, of said video monitor.

4. The vending apparatus (10) of claim 1 further comprising:
a speaker (24) coupled to said chassis and in communication with said video player, whereby an audio soundtrack that corresponds to said video presentation is broadcast by said speaker.

5. The vending apparatus (10) of claim 1 wherein:
said video player is one of the group consisting of a DVD player (31), a CD-ROM player (32), and a computer (33).

6. The vending apparatus (10) of claim 1 wherein:
said video player is a computer (33) having a memory (34, 35) and a display screen.

7. In vending apparatus (10) having a cabinet (11), a compartment (12) coupled to said cabinet and arranged for storing a supply of goods to be sold, a bin (16) coupled to said cabinet and arranged for presenting at least one of said supply of goods to a user, a dispenser mechanism (40) coupled to said compartment and arranged to selectively cause said at least one of said supply of goods to be transferred from said compartment to said bin, and an acceptor assembly (14) coupled to said cabinet and arranged for receiving a payment from said user, said acceptor assembly in communication with said dispenser mechanism for causing said dispenser mechanism to selectively cause said at least one of said supply of goods to be transferred from said compartment to said bin upon said acceptor assembly receiving said payment from said user, the improvement comprising:
means for displaying a stereoscopic video presentation (39) to said user upon said acceptor assembly receiving said payment from said user.

8. The vending apparatus (10) of claim 7 wherein said means for displaying a stereoscopic video presentation comprises:
a video monitor (36) coupled to said cabinet and arranged to be optically visible by said user; and
a video player (30) coupled to said cabinet and in communication with said video monitor and said acceptor assembly, said video player arranged for displaying a video presentation (39) on said video monitor upon said acceptor assembly receiving said payment from said user; and
a face plate (20) coupled to said cabinet, said faceplate having left and right ocular apertures (22L, 22R) and arranged so that said user can view said video presentation on said video monitor through at least one of said left and right ocular apertures.

9. The vending apparatus (10) of claim 8 wherein said means for displaying a stereoscopic video presentation further comprises:
a divider plate (25) coupled between said video display and said faceplate, said divider plate defining left and right view regions (38L, 38R) of said video display so that said user can see the left view region but not the right view region through said left ocular aperture and can see the right view region but not the left view region through said right ocular aperture;
wherein said video presentation is arranged to display left and right stereoscopic images on said left and right view images, respectively, of said video monitor.

10. The vending apparatus (10) of claim 7 wherein said means for displaying a stereoscopic video presentation comprises:
left and right video monitors (36) coupled to said cabinet and arranged to be optically visible by said user; and
at least one video player (30) coupled to said cabinet and in communication with said acceptor assembly and at least one of said left and right video monitors and arranged for displaying a video presentation (39) on said at least one of said left and right video monitors upon said acceptor assembly receiving said payment from said user; and
a face plate (20) coupled to said cabinet, said faceplate having left and right ocular apertures (22L, 22R), and arranged so that said user can view said left video monitor but not said right video monitor through said left ocular aperture and can view said right video monitor but not said left video monitor through said right ocular aperture.
